(19) United States
(12) Patent Application Publication
(10) Pub. No.: US 2006/0152470 A1
(43) Pub. Date: Jul. 13, 2006

(54) Liquid crystal display device and method of driving the same

(76) Inventor: Sang-Uk Kim, Suwon-si (KR)

Correspondence Address: ROBERT E. BUSHNELL, 1522 K STREET NW, SUITE 300, WASHINGTON, DC, 20005-1202, US

(21) Appl. No.: 11/328,459

(22) Filed: Jan. 10, 2006

(30) Foreign Application Priority Data
Jan. 10, 2005 (KR) 10-2005-0002299

(51) Int. Cl. G09G 3/36

(52) U.S. Cl. 345/102

(57) ABSTRACT

A liquid crystal display device and a method of driving the same. The liquid crystal display device includes a first substrate having a thin film transistor, a pixel electrode and a storage electrode, a second substrate having a common electrode, an optically compensated bend (OCB) mode liquid crystal layer filled between the first and the second substrates, a switching portion connected to the common electrode, connected to a DC-DC converter that outputs a transition voltage during bend transition time, and connected to the storage electrode after the bend transition time and a timing controller for outputting a control signal to control operation of the switching portion.

### CLAIM OF PRIORITY

This application makes reference to, incorporates the same herein, and claims all benefits accruing under 35 U.S.C. §119 from an application earlier filed in the Korean Intellectual Property Office on Jan. 15, 2005 and there duly assigned Serial No. 2005-2299.

### BACKGROUND OF THE INVENTION

1. Field of the Invention

A liquid crystal display (LCD) device and a method of driving the same and, more particularly, to an LCD device that rapidly changes an optically compensated bend (OCB) mode liquid crystal to a bend state from a splay state and a method of driving the same.

2. Description of the Related Art

An LCD device is thin in thickness, light in weight and low in power consumption compared to a cathode ray tube (CRT). The LCD device also has less electromagnetic wave emission than a CRT. Thus, the LCD device has been widely used as a display device in a portable information devices such as a cellular phone, a computer a personal digital assistant (PDA), etc.

However, the LCD has a narrow viewing angle resulting in different brightness and color being observed according to a direction that a user observes the screen. There have been attempts to resolve this viewing angle problem. For example, in order to improve the viewing angle of the LCD device, a technique that arranges a prism plate on a light guide panel to improve straightness of light emitted from a back light, so that brightness of a vertical direction is improved more than 30% is being put into practice. Also, a technique that provides a negative compensation film to improve a viewing angle is being employed.

Further, an In Plane Switching mode has been developed to achieve a wide viewing angle of 160° that has about the same viewing angle as a CRT. However, In Plane Switching is low in aperture ratio and thus in need of further improvement.

Other attempts to improve the viewing angle of an LCD device include the techniques of driving an optically compensated bend (OCB) method, a polymer dispersed liquid crystal (PDLC) method, a deformed helix ferroelectric (DHF) method using thin film transistors (TFTs). In particular, the OCB mode has undergone much research and development because it has a rapid liquid crystal response speed and a wide viewing angle. However, one problem with the OCB mode is that the pixels are easily damaged. Therefore, what is needed is an improved design for an LCD panel and a method of driving the same that results in superior viewing angle and fast response speed without damaging the pixels.

### SUMMARY OF THE INVENTION

It is therefore an object of the present invention to provide an improved design for an LCD panel.

It is also an object of the present invention to provide an improved method of driving an LCD panel.

It is yet an object of the present invention to provide a design for an LCD panel that results in a wide range of viewing angles, fast response speed while protecting the pixels from damage.

It is further an object of the present invention to provide a method of driving an LCD that results in a wide range of viewing angles, fast response speed and does not harm the pixels.

It is still an object of the present invention to provide an LCD device that can apply a transition voltage only to a common electrode of an upper substrate during initial bend transition to rapidly bend-transit a liquid crystal in OCB mode, and a method of driving the same.

These and other objects can be achieved by a liquid crystal display device that includes a first substrate including a thin film transistor, a pixel electrode and a storage electrode, a second substrate including a common electrode, an optically compensated bend (OCB) mode liquid crystal layer filled between the first and the second substrates, a switching portion connected to the common electrode, the switching portion also being connected to a DC-DC converter that outputs a transition voltage during a bend transition time, and to the storage electrode after the bend transition time, and a timing controller adapted to output a control signal to control operation of the switching portion.

The present invention further provides a liquid crystal display device that includes a liquid crystal panel including a plurality of pixels, each pixel including a liquid crystal capacitor of an optically compensated bend (OCB) mode and a storage capacitor, a scan driver adapted to transmit a gate signal to the plurality of pixels through a plurality of gate lines, a source driver adapted to transmit a data voltage to the plurality of pixels through a plurality of data lines, a DC-DC converter adapted to output a transition voltage to bend-transit a liquid crystal of the OCB mode, a switching portion connected to a common electrode of the liquid crystal capacitor, the switching portion being adapted to switch to the DC-DC converter during a bend transition time and switch to a storage electrode of the storage capacitor after the bend transition time, and a timing controller adapted to output a control signal to control operation of the scan driver, the source driver and the switching portion.

The present invention also provides a method of driving a liquid crystal display device that includes the a liquid crystal display device that has a first substrate having a thin film transistor, a pixel electrode and a storage electrode, a second substrate having a common electrode, and an optically compensated bend (OCB) mode liquid crystal filled between the first and the second substrates switching to a DC-DC converter allowing for output of a transition voltage at a switching portion connected to the common electrode and switching to the storage electrode at the switching portion.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in that like reference symbols indicate the same or similar components, wherein:

FIG. 1 is a view illustrating states of a liquid crystal used to describe operation of an optically compensated bend (OCB) mode;

FIG. 2 is a view of a block diagram illustrating an OCB mode LCD device;

FIG. 3 is a view of block diagram illustrating an OCB mode LCD device according to the present invention;

FIG. 4 is a cross-sectional view illustrating a unit pixel in order to explain the operation of the LCD device of the present invention; and

FIGS. 5A to 5E are views of circuit diagrams illustrating a switching portion according to the present invention.

### DETAILED DESCRIPTION OF THE INVENTION

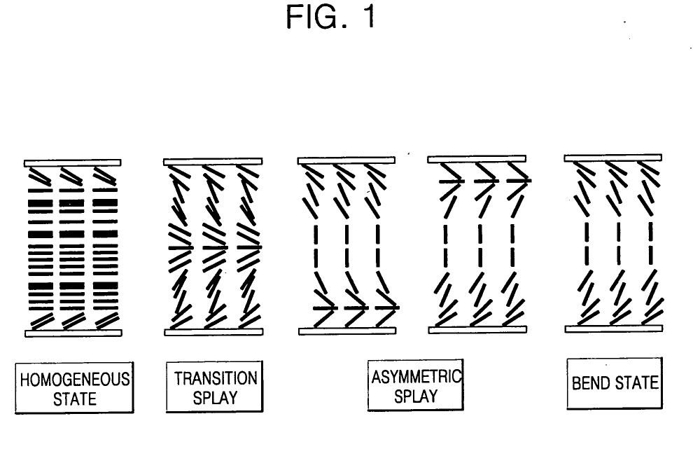

Turning now to the figures, FIG. 1 is a view illustrating states of a liquid crystal in order to describe operation of an optically compensated bend (OCB) mode. Referring to FIG. 1, an initial orientation state of a liquid crystal arranged between an upper plate electrode and a lower plate electrode is a homogenous state, and when a predetermined voltage is applied to the upper and lower plate electrodes, the state of the liquid crystal changes from a transient splay and an asymmetric splay to a bend state and then operates in an OCB mode. As illustrated in FIG. 1, an OCB liquid crystal cell has a tilt angle of about 10° to 20°, thickness of the liquid crystal cell is about 4 to 7 μm, and an orientation film is rubbed in the same direction.

Liquid crystal molecules in the central portion of a liquid crystal layer are left-and-right symmetrically arranged, and thus a tilt angle is 0° at a voltage of less than a predetermined level. The tilt angle is 90° at a voltage of more than a predetermined level. A high voltage is initially applied so that the tilt angle of the liquid crystal molecules in the central portion of the liquid crystal layer becomes 90°. Then the magnitude of the applied voltage varies so that the tilt angle of the liquid crystal molecules at locations other than at the central portion of the liquid crystal layer is changed, thus modulating polarization of light that passes through the liquid crystal layer.

It takes tens of seconds to change the tilt angle of the liquid crystal molecules in the central portion from 0° to 90°, and a response time is as fast as 10 μsec because there is no a back flow and because there is a big bending transformation that has a large elastic modulus.

In general, when the OCB mode is in an ON state, conversion of from the transient splay to the asymmetric splay is fast, and conversion of from the transient splay to the bend state is relatively fast, but conversion of from the asymmetric splay to the bend state is slow. When the OCB mode is in an OFF state, conversion to the homogenous state is slow but conversion from the transient splay to the homogenous state or from the asymmetric splay to the homogenous state is fast.

As described above, there is a problem in that a predetermined time (hereinafter, “transient time”) elapses before the bend orientation for the OCB mode is achieved. Therefore, an LCD device uses a method of applying an initial voltage to a common electrode of the liquid crystal in order to reduce the transient time in the OCB mode.

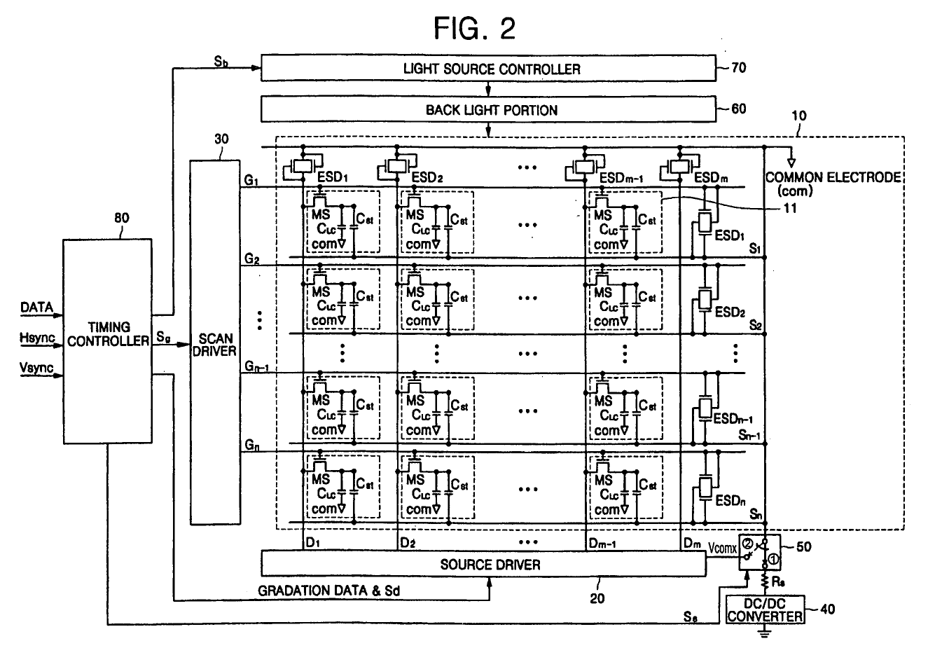

Turning now to FIG. 2, FIG. 2 is a view of a block diagram illustrating an OCB mode LCD device. Referring to FIG. 2, the OCB mode LCD device includes a liquid crystal (LC) panel 10, a source driver 20, a scan driver 30, a DC-DC converter 40, a switching portion 50, a back light portion 60, a light source controller 70, and a timing controller 80.

Electro static discharge (ESD) circuits ESD1 to ESDm are connected between storage lines S1 to Sn and data lines D1 to Dm. ESD circuits ESD1 to ESDn are connected between the storage lines S1 to Sn and gate lines G1 to Gn. The switching portion 50 is commonly connected to the storage lines S1 to Sn as well as a common electrode and is switched to distinguish initial bend transition operation and liquid crystal driving operation according to a control signal Ss from the timing controller 80.

In the OCB mode LCD device of FIG. 2, during initial bend transition of the liquid crystal, the switching portion 50 is switched to a position \textcircled{1} according to the control signal Ss of the timing controller 80, so that a high voltage of 15 volts to 30 volts from DC/DC converter 40 is applied to the storage lines S1 to Sn and the common electrode (com) through a series resistor Rs. Specifically, a voltage output from the DC-DC converter 40 drops by a predetermined level due to the series resistor Rs, and the high voltage applied through the series resistor Rs turns on the ESD circuits ESD1 to ESDm connected to the data lines D1 to Dm, so that a high voltage of a desired level is not applied to the liquid crystal.

When the series resistor Rs having small resistance to solve the problem is provided, a level of a voltage Vd applied to the liquid crystal can be increased. However, if the series resistor Rs has small resistance, a high current flows at an initial stage that a voltage is applied, so that thin film transistor (TFT) pixels or the liquid crystal panel may be damaged.

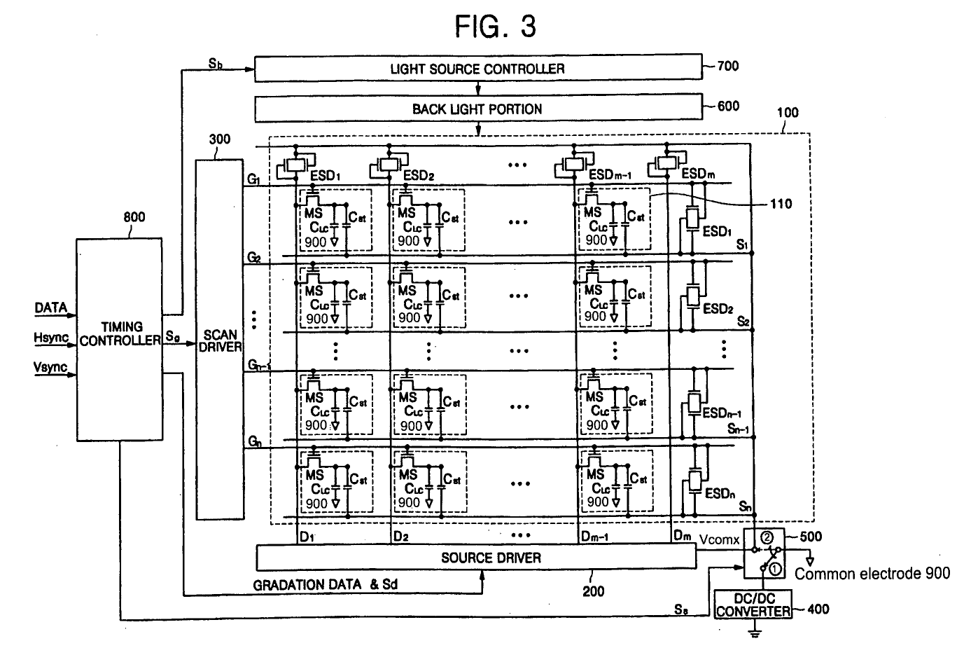

Turning now to FIG. 3, FIG. 3 is a view of a block diagram illustrating an OCB mode LCD device according to the present invention. Referring to FIG. 3, the OCB mode LCD device includes an LC panel 100, a source driver 200, a scan driver 300, a DC-DC converter 400, a switching portion 500, a back light portion 600, a light source controller 700, and a timing controller 800. The LC panel 100 includes a lower substrate (not shown) and an upper substrate (not shown) with an OCB mode liquid crystal interposed therebetween.

On the lower substrate, a plurality of gate lines G1 to Gn that transmit gate signals, a plurality of data lines D1 to Dm that transmit data signals, a plurality of storage lines S1 to Sn, and a plurality of pixel regions that contain thin film transistors (TFTs) formed at crossing points of the gate lines G1 to Gn and the data lines D1 to Dm are formed. On the upper substrate, a common electrode that is an upper electrode of capacitor C_{LC} (LC capacitor), red (R), green (G) and blue (B) color filters (not provided for field sequential driving method), and a black matrix are provided.

The LC panel 100 includes a plurality of pixels 110. Each pixel 110 includes a switching transistor MS, capacitor C_{LC}, and a storage capacitor Cst. The switching transistor MS includes a source, a gate and a drain. The source is connected to the data line Dm, the gate is connected to the gate line Gn, and the drain is connected to a pixel electrode of capacitor C_{LC}. The switching transistor MS is turned on in response to a gate signal transmitted through the gate line Gn, allowing switching transistor MS to transmit a data voltage from the data line Dm to capacitor C_{LC}.

Capacitor C_{LC} includes a pixel electrode (not shown) and a common electrode 900 with an OCB mode liquid crystal filled therebetween. The pixel electrode of capacitor C_{LC} is connected to the drain of the switching transistor MS and is substantially provided with data voltages transmitted through the switching transistor MS. The common electrode 900 of capacitor C_{LC} is formed on the upper substrate and is arranged to face the pixel electrode. A high voltage is applied to the common electrode 900 from an external power source during an initial bend transition of the liquid crystal, and a common voltage Vcom is applied to the common electrode 900 from the source driver 200 during liquid crystal driving. The liquid crystal is rapidly changed to a bend state by the high voltage applied to the common electrode 900 during initial bend transition, and the arrangement state of the liquid crystal varies according to a voltage difference between the data voltage Vdata and a common voltage Vcom that are applied to both terminals of capacitor C_{LC} while the liquid crystal is being driven.

The storage capacitor Cst includes the pixel electrode and a storage electrode Sn with a dielectric material layer formed therebetween. A common voltage Vcom is applied to the storage electrode Sn from the source driver 200 while the liquid crystal is being driven. Thus, the storage capacitor Cst is connected in parallel to the capacitor C_{LC} to store charges corresponding to a voltage difference between a data voltage Vdata and a common voltage Vcom during one frame.

The source driver 200 is connected to a plurality of data lines D1 to Dm that transmit a data voltage to the plurality of pixels 110. The source driver 200 is also connected to a common voltage line Vcomx that transmits a common voltage Vcom to the storage line Sn so that the common voltage Vcom can be delivered to the common electrode 900 of capacitor C_{LC} in pixels 110. The source driver 200 grounds the plurality of data lines D1 to Dm during initial bend transition of the liquid crystal, and applies to the plurality of pixels 110 a data voltage through the plurality of data lines D1 to Dm and a common voltage Vcom through the common voltage line Vcomx when the liquid crystal is being driven.

The scan driver 300 is connected to a plurality of gate lines G1 to Gn that transmit gate signals to the plurality of pixels 110. The scan driver 300 turns on the MS transistors of the pixels 110 by applying a voltage to the gates of the MS transistors during initial bend transition of the liquid crystal, and sequentially applies the gate signals through the gate lines G1 to Gn to select a plurality of pixels 110 while the liquid crystals are being driven.

The DC-DC converter 400 boosts a voltage from a power source (not shown) to output a voltage of 15 volts to 30 volts. The DC-DC converter 400 applies a high voltage to the common electrode 900 to rapidly change the OCB mode liquid crystal to a bend state from a splay state during initial bend transition of the liquid crystal.

The switching portion 500 operates a switch fixed to the common electrode 900 of the upper substrate to distinguish initial bend transition operation from the driving operation. First, during initial bend transition of the liquid crystal, the switching portion 500 is switched to a position \textcircled{1} to apply a voltage output from the DC-DC converter 400 to the common electrode 900. As described above, a voltage output from the DC-DC converter 400 is substantially in a range between 15 volts and 30 volts. Then, during driving operation of the liquid crystal, the switching portion 500 is switched to a position \textcircled{2} to be connected to the storage lines S1 to Sn to thus apply a common voltage Vcom output from the source driver 200 to the storage lines S1 to Sn and to the common electrode 900.

The timing controller 800 receives video data DATA, a horizontal synchronous signal Hsync, and a vertical synchronous signal Vsync from an external video processing portion (not shown) and applies gradation data and an operation control signal Sd to the source driver 200 and applies control signals Sg, Sb, and Ss to the scan driver 300, the light source controller 700 and the switching portion 500, respectively.

The light source controller 700 applies a predetermined voltage to back light portion 600 arranged on a rear surface of the LC panel 100 according to a back light control signal Sb supplied from the timing controller 800. The back light portion 600 can include a red LED, a green LED, and a blue LED that sequentially outputs red, green and blue light to one pixel when a field-sequential driving method is used. Alternatively, the back light portion 600 can include a white LED or a cold cathode fluorescence lamp (CCFL) that outputs white light when a driving method using a color filter is used. When the LCD device uses a driving method using a color filter, red, green and blue color filters are located on each unit pixel.

The ESD circuits ESD1 to ESDm for electrostatic discharge are connected between the storage lines S1 to Sn and the data lines D1 to Dm, and ESD circuits ESD1 to ESDn are connected between the storage lines S1 to Sn and the gate lines G1 to Gn. The ESD circuit discharge electrostatic charges that can occur during the manufacturing process of the LCD device without changing characteristics of the TFTs or wire lines. The ESD circuit is turned on when a voltage of more than a predetermined level (e.g., 10 volts) is applied causing the ESD circuit to function as a resistor whose resistance depends on the applied voltage. For the LCD device of FIG. 2, during the initial bend transition, the ESD circuits ESD1 to ESDn and ESD1 to ESDm are turned on by a high voltage output from the DC-DC converter 40 and thus serve to obstruct application of a high voltage to the liquid crystal. However, for the LCD device of FIG. 3, during the initial bend transition of the liquid crystal, the DC-DC converter 400 applies a high voltage only to the common electrode 900 but does not apply a high voltage to the storage lines S1 to Sn, and thus the ESD circuits ESD1 to ESDn and ESD1 to ESDm are not affected by the DC-DC converter 400 at all, thus the above described problem of the LCD device of FIG. 2 does not occur in the LCD device of FIG. 3.

As described above, the OCB mode LCD device of the present invention has the switching portion 500 that electrically disconnects the common electrode 900 on the upper substrate from the storage lines S1 to Sn on the lower substrate during the initial bend transition of the liquid crystal, so that a high voltage is applied only to the common electrode 900 but is not applied to the storage lines S1 to Sn. Thus, when a circuit and a driver IC are designed on the lower substrate, a high voltage applied to the lower substrate does not need to be considered. Also, during the initial bend transition of the liquid crystal, the ESD circuits ESD1 to ESDn and ESD1 to ESDm are not affected at all by the high voltage supplied from the DC-DC converter 400, so that a high voltage can be sufficiently applied to the liquid crystal, thus reducing the bend transition time of the liquid crystal.

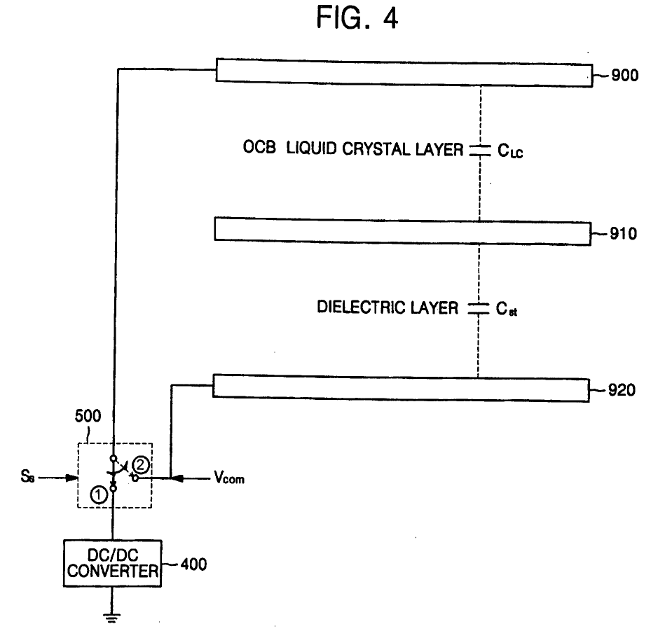

Turning now to FIG. 4, FIG. 4 is a cross-sectional view illustrating a unit pixel to explain operation of the LCD device of the present invention. Referring to FIG. 4, the pixel 110 includes the common electrode 900, the pixel electrode 910, and the storage electrode 920. An OCB mode liquid crystal layer is filled between the common electrode 900 and the pixel electrode 910, and a dielectric material layer is formed between the pixel electrode 910 and the storage electrode 920. Thus, the common electrode 900, the pixel electrode 910 and the OCB mode liquid crystal layer form capacitor C_{LC}, and the pixel electrode 910, the storage electrode 920 and the dielectric material layer form storage capacitor Cst.

The switching portion 500 is connected to the common electrode 900 to perform a switching operation such that the common electrode 900 is connected to the DC-DC converter 400 during the initial bend transition and the common electrode 900 is connected to the storage electrode 920 during liquid crystal driving. Designs of the switching portion 500 will be explained later in detail.

A driving method of the LCD device of the present invention is explained with reference to FIGS. 3 and 4. During the initial bend transition of the liquid crystal, the source driver 200 grounds the plurality of data lines D1 to Dm according to a control signal Sd from the timing controller 800. Thus, the pixel electrode 910 is substantially connected to a ground during the initial bend transition. The switching portion 500 is switched to a position \textcircled{1} according to a control signal Ss from the timing controller 800 so that a transition voltage output from the DC-DC converter 400 can be supplied to the common electrode 900. Thus, capacitor C_{LC} is rapidly changed from a splay state to a bend state so that the drive of the liquid crystal is ready.

Then, during the driving of the liquid crystal, the source driver 200 supplies data voltage Vdata to the plurality of data lines D1 to Dm according to a control signal Sd received from the timing controller 800, so that data voltage Vdata is applied to the pixel electrode 910. The switching portion 500 is switched to a position \textcircled{2} according to a control signal Ss from the timing controller 800 so that the common electrode 900 is now connected to the storage electrode 920, and a common voltage Vcom is supplied from the source driver 200. Thus, arrangement of the liquid crystal varies with transmittance of the liquid crystal corresponding to a difference between voltages applied to both terminals of capacitor C_{LC}, while storage capacitor Cst stores a voltage corresponding to the difference between voltages applied to both terminals of capacitor C_{LC} during one frame.

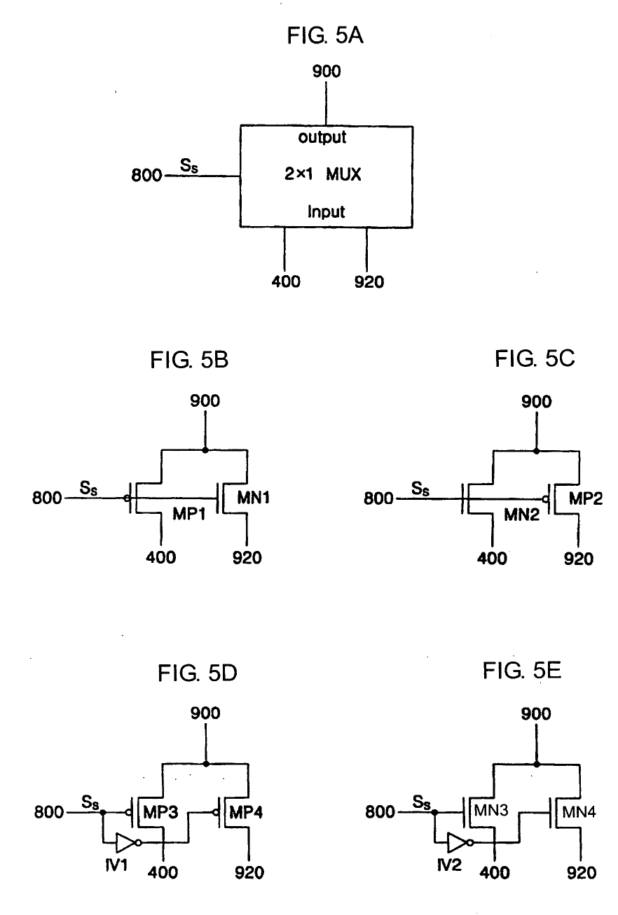

Turning now to FIGS. 5A through 5E, FIGS. 5A to 5E are views of circuit diagrams illustrating the switching portion 500 according to the present invention. Referring to FIG. 5A, the switching portion 500 can include a 2×1 multiplex. In more detail, the 2×1 multiplex includes a control terminal connected to the timing controller 800, a first input terminal connected to the DC-DC converter 400, a second input terminal connected to the storage electrode 920, and an output terminal connected to the common electrode 900. The 2×1 multiplex selectively connects the common electrode 900 to either the DC-DC converter 400 or the storage electrode 920 according to a control signal Ss received from the timing controller 800.

Referring to FIGS. 5B and 5C, the switching portion 500 can include one PMOS transistor and one NMOS transistor. In FIG. 5B, the PMOS transistor MP1 has a first terminal connected to the common electrode 900, a second terminal connected to the DC-DC converter 400, and a gate terminal connected to a control signal line Ss of the timing controller 800. The NMOS transistor MN1 has a first terminal connected to the common electrode 900, a second terminal connected to the storage electrode 920, and a gate electrode connected to the control signal line Ss of the timing controller 800. If a control signal Ss of the timing controller 800 has a low level, only PMOS transistor MP1 is turned on allowing the high voltage of the DC-DC converter 400 to pass to the common electrode 900. If the control signal Ss of the timing controller 800 has a high level, only NMOS transistor MN1 is turned on allowing the storage electrode 920 to be connected to the common electrode 900 so that a common voltage Vcom can be supplied to the common electrode 900.

Alternatively, the transistors MP1 and MN1 can instead be switched around as in FIG. 5C. In FIG. 5C, the NMOS transistor MN2 has a first terminal connected to the common electrode 900, a second terminal connected to the DC-DC converter 400, and a gate terminal connected to a control signal line Ss of the timing controller 800. The PMOS transistor MP2 has a first terminal connected to the common electrode 900, a second terminal connected to the storage electrode 920, and a gate electrode connected to the control signal line Ss of the timing controller 800. If a control signal Ss of the timing controller 800 has a high level, only NMOS transistor MN2 is turned on allowing the high voltage of the DC-DC converter 400 to pass to the common electrode 900. If the control signal Ss of the timing controller 800 has a low level, only PMOS transistor MP2 is turned on allowing the storage electrode 920 to be connected to the common electrode 900 so that a common voltage Vcom can be supplied to the common electrode 900.

Referring now to FIGS. 5D and 5E, the switching portion 500 can include two PMOS transistors or two NMOS transistors. In FIG. 5D, where there are two PMOS transistors, PMOS transistor MP3 has a first terminal connected to the common electrode 900, a second terminal connected to the DC-DC converter 400, and a gate terminal connected to the control signal line Ss of the timing controller 800. The PMOS transistor MP4 has a first terminal connected to the common electrode 900, a second terminal connected to the storage electrode 920, and a gate terminal connected to one side of inverter IV1, the other side of the inverter IV1 being connected to the control signal line Ss of the timing controller 800. If a control signal Ss of the timing controller 800 has a low level, only PMOS transistor MP3 is turned on allowing the high voltage of the DC-DC converter 400 to pass to the common electrode 900. In FIG. 5D, if the control signal Ss of the timing controller 800 has a high level, only PMOS transistor MP4 is turned on so that the storage electrode 920 is connected to the common electrode allowing common voltage Vcom to pass to the common electrode 900.

The two PMOS transistors MP3 and MP4 can be replaced with the two NMOS transistors MN3 and MN4 as illustrated in FIG. 5E. In FIG. 5E, the NMOS transistor MN3 has a first terminal connected to the common electrode 900, a second terminal connected to the DC-DC converter 400, and a gate terminal connected to the control signal line Ss of the timing controller 800. The NMOS transistor MN4 has a first terminal connected to the common electrode 900, a second terminal connected to the storage electrode 920, and a gate terminal connected to one side of inverter IV2, the other side of the inverter IV2 being connected to the control signal line Ss of the timing controller 800. If a control signal Ss of the timing controller 800 has a high level, only NMOS transistor MN3 is turned on allowing the high voltage of the DC-DC converter 400 to pass to the common electrode 900. In FIG. 5E, if the control signal Ss of the timing controller 800 has a low level, only NMOS transistor MN4 is turned on connecting the storage electrode 920 to the common electrode so that the common voltage Vcom can pass to the common electrode 900.

As described above, the OCB mode LCD device of the present invention has the switching portion 500 to electrically disconnect the common electrode 900 on the upper substrate from the storage lines S1 to Sn on the lower substrate during the initial bend transition of the liquid crystal according to a control signal Ss supplied from the timing controller 800. This allows the high voltage from the DC-DC converter 400 to be applied only to the common electrode 900 without applying the high voltage to the lower substrate. Thus, when a circuit and a driver IC are designed on the lower substrate, a high voltage applied to the lower substrate does not need to be considered. Also, during the initial bend transition of the liquid crystal, the ESD circuits ESD1 to ESDn and ESD1 to ESDm are not at all affected by a high voltage supplied from the DC-DC converter 400, so that a high voltage can be sufficiently applied to the liquid crystal, thus reducing the bend transition time of the liquid crystal.

As described above, according to the OCB mode LCD device of the present invention, a high voltage from the DC-DC converter is applied only to the common electrode but not to the storage electrode during the initial bend transition of the liquid crystal when a circuit and a driver IC are designed on the lower substrate. Therefore, a high voltage applied to the storage electrode does not need to be considered. Also, during the initial bend transition of the liquid crystal, the ESD circuits are not at all affected by a high voltage supplied from the DC-DC converter 400, so that a high voltage can be sufficiently applied to the liquid crystal, thus reducing the bend transition time of the liquid crystal.

While the present invention has been particularly shown and described with reference to exemplary embodiments thereof, it will be understood by those of ordinary skill in the art that various changes in form and details maybe made therein without departing from the spirit and scope of the present invention as defined by the following claims.

What is claimed is:

1. A liquid crystal display device, comprising:
a first substrate including a thin film transistor, a pixel electrode and a storage electrode;
a second substrate including a common electrode;
an optically compensated bend (OCB) mode liquid crystal layer filled between the first and the second substrates;
a switching portion connected to the common electrode, the switching portion also being connected to a DC-DC converter that outputs a transition voltage during a bend transition time, and being connected to the storage electrode after the bend transition time; and
a timing controller adapted to output a control signal to control operation of the switching portion.

2. The device of claim 1, wherein the switching portion is a multiplex that includes:
a control terminal connected to the timing controller;
a first input terminal connected to the DC-DC converter;
a second input terminal connected to the storage electrode; and
an output terminal connected to the common electrode.

3. The device of claim 1, wherein the switching portion includes:
a first transistor connected between the common electrode and the DC-DC converter; and
a second transistor connected between the common electrode and the storage electrode, wherein the first and the second transistors are adapted to be complementarily turned on or off according a control signal from the timing controller.

4. The device of claim 3, wherein the first transistor is a PMOS transistor, the second transistor is an NMOS transistor, the control signal of the timing controller has a low level during the bend transition time, and the control signal of the timing controller has a high level after the bend transition time.

5. The device of claim 3, wherein the first transistor is an NMOS transistor, the second transistor is a PMOS transistor, the control signal of the timing controller has a high level during the bend transition time, and the control signal of the timing controller has a low level after the bend transition time.

6. The device of claim 3, wherein the switching portion further includes an inverter connected between a gate of one of the first and the second transistors and the timing controller.

7. The device of claim 6, wherein the first and the second transistors are both PMOS transistors.

8. The device of claim 6, wherein the first and the second transistors are both NMOS transistors.

9. The device of claim 1, wherein a transition voltage of the DC-DC converter is in a range between 15 volts and 30 volts.

10. The device of claim 1, wherein the second substrate further includes a color filter adapted to implement a color on the common electrode.

11. A liquid crystal display device, comprising:
a liquid crystal panel including a plurality of pixels, each pixel including a liquid crystal capacitor of an optically compensated bend (OCB) mode and a storage capacitor;
a scan driver adapted to transmit a gate signal to the plurality of pixels through a plurality of gate lines;
a source driver adapted to transmit a data voltage to the plurality of pixels through a plurality of data lines;
a DC-DC converter adapted to output a transition voltage to bend-transit a liquid crystal of the OCB mode;
a switching portion connected to a common electrode of each liquid crystal capacitor, the switching portion being adapted to switch to the DC-DC converter during a bend transition time and to switch to a storage electrode of the storage capacitor after the bend transition time; and
a timing controller adapted to output a control signal to control operation of the scan driver, the source driver and the switching portion.

12. The device of claim 11, wherein the transition voltage of the DC-DC converter is in a range between 15 volts and 30 volts.

13. The device of claim 12, wherein the source driver is adapted to ground the plurality of data lines during the bend transition time.

14. The device of claim 1 1, wherein the source driver is adapted to apply a data voltage to the plurality of data lines after the bend transition time and apply a common voltage to the storage electrode.

15. The device of claim 11, further comprising a back light portion that includes a red LED, a green LED and a blue LED that sequentially emits red, green and blue light respectively to the liquid crystal panel.

16. The device of claim 11, further comprising a back light portion that includes one of a white LED and a cold cathode fluorescence lamp (CCFL) that emits white light to the liquid crystal panel.

17. The device of claim 16, wherein the liquid crystal panel further includes red, green and blue color filters adapted to filter light emitted from the back light portion.

18. The device of claim 11, wherein each pixel further includes a switching transistor adapted to transmit to the liquid crystal panel a data voltage transferred through one of said plurality of data line in response to a control signal of the gate line.

19. A method, comprising:
providing a liquid crystal display device that includes a first substrate having a thin film transistor, a pixel electrode and a storage electrode, a second substrate having a common electrode, and an optically compensated bend (OCB) mode liquid crystal filled between the first and the second substrates;
switching a switching portion to connect the common electrode to a DC-DC converter allowing for output of a transition voltage; and
switching the switching portion to connect the common electrode to the storage electrode.

20. The method of claim 19, wherein upon the switching of the switching portion to connect the common electrode to the DC-DC converter, the OCB mode liquid crystal is changed from a splay state to a bend state.

21. The method of claim 19, wherein the transition voltage of the DC-DC converter is in a range between 15 volts and 30 volts.

22. The method of claim 21, wherein upon the switching of the switching portion to connect the common electrode to the DC-DC converter, the pixel electrode is connected to a ground.

23. The method of claim 19, wherein upon the switching of the switching portion to connect the common electrode to the storage electrode, a common voltage is applied to the storage electrode.
